(19) United States
(12) Patent Application Publication
(10) Pub. No.: US 2009/0134009 A1
(43) Pub. Date: May 28, 2009

(54) DEVICE FOR CONTROLLING THE DISPLACEMENT OF A VOLUME OF LIQUID BETWEEN TWO OR MORE SOLID SUBSTRATES AND DISPLACEMENT METHOD

(76) Inventors: Jean Maxime Roux, Grenoble (FR); Jean Luc Achard, Grenoble (FR); Yves Fouillet, Voreppe (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/997,498

(22) PCT Filed: Jul. 24, 2006
(86) PCT No.: PCT/EP06/07281

§ 371 Date: Jul. 28, 2008

(30) Foreign Application Priority Data
Aug. 2, 2005 (FR) 0508220

(51) Int. Cl. B01J 19/08

(52) U.S. Cl. 204/164; 422/186.04

(57) ABSTRACT

The invention relates to a device for displacing a volume of liquid (1) under the action of an electrical voltage, comprising: iv) a first substrate with a first electrode (4,5); v) a second substrate with a second electrode (4, 5) facing the first substrate; vi) means for applying a first voltage (3) between the first and the second electrode, one of the two electrodes comprising, in essence, a matrix (5) consisting of a number of microelectrodes and having means for applying a second voltage between two microelectrodes. The invention also relates to a method for displacing a volume of liquid (1).

### TECHNICAL FIELD AND PRIOR ART

The present invention relates to the displacing and controlling of conductive and optionally polar microdrops in a dielectric or weakly conductive liquid medium which is immiscible with the drops, using electrohydrodynamic forces, between two or more positions that may correspond to specific contact zones on solid substrates.

A commonly encountered technique for displacing drops using electrostatic forces is electrowetting on dielectric (EWOD). Devices based on this technique consist of a matrix of insulated electrodes coated with a hydrophobic layer, the wetting of which exhibits very weak hysteresis. The drops to be displaced are placed on this hydrophobic surface and in contact with a bare electrode which polarizes them. The displacement of a drop above an insulated electrode adjacent to the drop is carried out by applying a voltage between the electrode in question and the electrode which polarizes the drop. This technique is very sound, but the quality of the hydrophobic surface in contact with the drops to be displaced is an essential point to be controlled in the fabrication of the systems.

Another technique for displacing drops is based on dielectrophoretic forces. The device is similar to that used to displace the drops by electrowetting, but does not comprise a bare electrode in contact with the drops, and therefore the electric potential of the drops is not fixed. The displacement is brought about by applying electrical voltages between the electrodes of the matrix so as to create nonuniform field zones. The drops displaced according to this technique may once again be in contact with a solid surface and the quality of this surface remains an essential point, or else may be in suspension at the interface between two immiscible fluids. In this case, the drops are in levitation. In the latter case, it is necessary to maintain the fluid/fluid interface along which the drop is displaced, parallel to the matrix of electrodes, which amounts to imposing the condition that the microsystem remains horizontal.

Particles or cells may also be manipulated using electric fields by dielectrophorosis. The particles are trapped in wells having electrostatic potentials. The particles can be maintained in levitation, out of contact with a solid surface, by this technique. The electric fields used are alternating electric fields of quite high frequency.

U.S. Pat. No. 5,486,337 A describes a device for displacing drops from one electrode to another by applying a voltage between the two electrodes. In contact with the first and under the effect of the electric field, the drop to be displaced is charged and then, under the effect of the electrostatic force to which it is subjected, leaves the electrode to move to the second. The drawback of this method once again lies in the prolonged contacts with solid elements, in particular wetting elements.

An advantageous technique for displacing drops without contact consists in causing them to float at the interface between two superimposed fluids, the densities of which flank that of the drop. A matrix of electrodes makes it possible to exert electrostatic forces on the drops in order to displace them (Orlin D. Velev, Nature, 4 Dec. 2003). However this technique is difficult to implement. It is necessary for the interface between the two fluids to be horizontal and parallel to the electrodes of the matrix.

The objective of the present invention is therefore to find a method for doing away with the constraints hanging over the quality of the solid surfaces.

An additional problem concerns the displacement of drops in which certain constituents might attach to the solid surfaces.

### DESCRIPTION OF THE INVENTION

The present invention therefore relates to a device for displacing a volume of liquid under the action of an electrical voltage, comprising:
i) a first substrate with a first electrode,
ii) a second substrate with a second electrode, facing (in general above) the first substrate,
iii) means for applying a first voltage between the first and the second electrode,
   one of the two electrodes comprising essentially a matrix consisting of a number of microelectrodes and having means for applying a second voltage between at least two microelectrodes.

The present invention also relates to a method for displacing a volume of liquid, in which said volume is initially in contact with a first substrate with the first electrode, comprising the following steps:
a) applying a first voltage between the first and the second electrode,
b) applying a second voltage between at least two microelectrodes of a matrix consisting of a number of microelectrodes;
   the amplitude of the first voltage (3) is such that the electrostatic forces exerted on the volume of liquid (1) to be displaced make it possible to detach it from the first electrode and the half-period τ of the first voltage (3) is less than the time of flight Tᵥ of the volume of liquid (1) between the two electrodes (4, 5).

The volume of liquid is generally immersed in a dielectric medium.

The voltage between the first and the second electrode is in general an alternating voltage.

Other features and advantages of the invention will emerge from the description which follows, with reference to the figures of the attached drawings. The exemplary embodiments described with reference to the drawings attached hereto are in no way limiting.

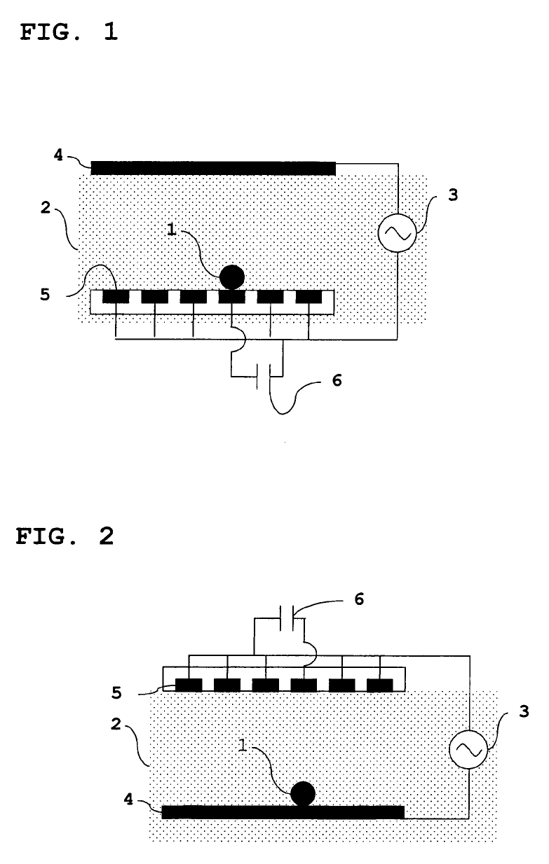

FIG. 1 illustrates a device and a method according to the present invention.

FIG. 2 illustrates another device and a method according to the present invention.

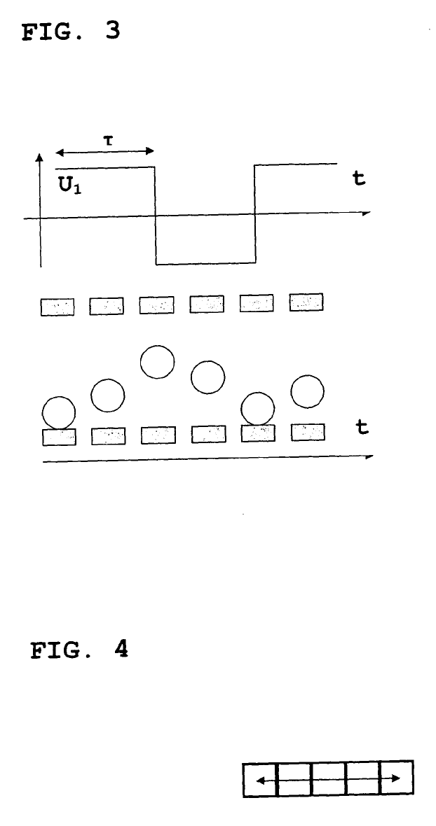

FIG. 3 illustrates the principle of vertical displacement of a volume of liquid under the action of an electrical voltage and dependent on the electrical voltage.

FIG. 4 illustrates an arrangement of microelectrodes and a possible displacement of a drop above this matrix.

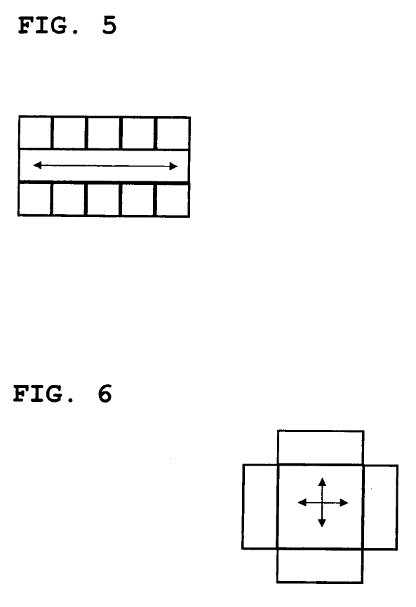

FIG. 5 illustrates an arrangement of microelectrodes and a possible displacement of a drop above this matrix.

FIG. 6 illustrates an arrangement of microelectrodes and a possible displacement of a drop above this matrix.

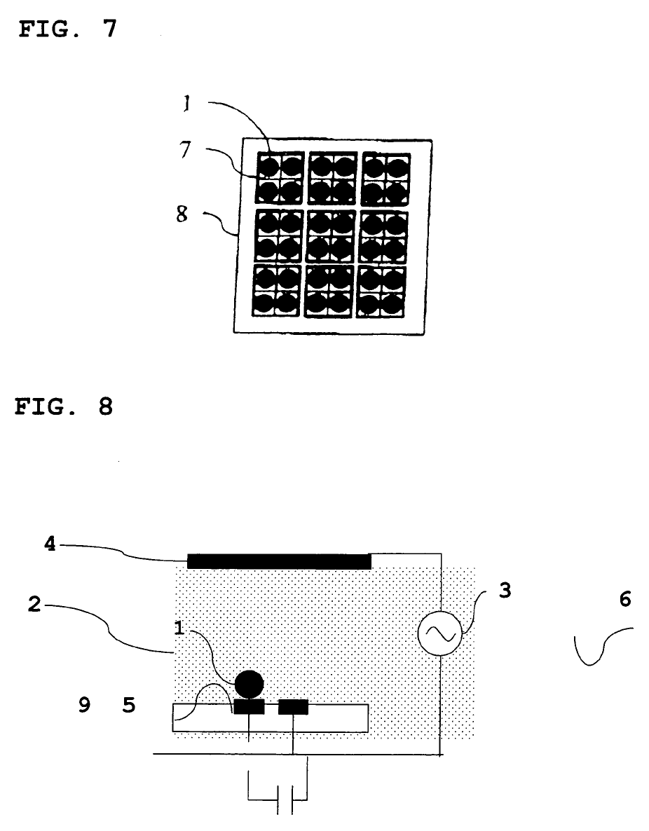

FIG. 7 illustrates an exemplary embodiment according to the present invention using dyes for producing a display device.

FIG. 8 illustrates the principle of coalescence of two drops.

In the figures, identical reference numbers are used to denote identical parts.

FIG. 1 illustrates a device and a method according to the present invention. In FIG. 1, 1 refers to a volume of liquid (in this case a conductive drop), 2 refers to a dielectric liquid medium, 3 refers to a first alternating voltage between an electrode 4 and a matrix of electrodes 5 separated by a distance greater than the diameter of the drop to be displaced, and then to the application of a second voltage 6.

FIG. 1 illustrates an exemplary embodiment of the present invention in which the lower support comprising the matrix of electrodes 5 is a printed circuit. The electrodes 4 or 5 are constituted of a conducting material. The conducting material is preferably copper or another metal. No surface treatment is necessary.

However, the surface of the electrodes, in particular lower electrodes, is advantageously textured. These surfaces may, for example, consist of pads or a network of walls. Furthermore, the surface of the lower substrate is advantageously hydrophobic. A very thin layer (a few hundred angstroms) of Teflon is, for example, deposited.

The gap between the electrodes 4 and 5 is greater than the diameter of the drop and can vary in the present invention. In general, the gap between the microelectrodes is less than the diameter of the volume of liquid (of the drops) to be displaced. In the present invention, it is preferred for the gap between the microelectrodes to be from 1 to 500 μm.

The upper electrode 4 is advantageously made of glass or polycarbonate coated with a transparent conductive film such as ITO.

A surface treatment is not necessary. However, it could be advantageous for the surface(s) of the electrodes to be textured. The texture advantageously provides pads or a network of walls.

The dielectric 2 in general has a density lower than and close to the liquid 1 to be displaced, thus reducing the amplitude of the first voltage. It is advantageous for the difference in density between the liquid 1 and the liquid dielectric 2 to be approximately 0.1.

FIG. 2 illustrates a device and a method according to the present invention in which 1 refers to a volume of liquid (in this case a conductive drop), 2 refers to a dielectric liquid medium, 3 refers to a first alternating voltage between an electrode 4 and a matrix of electrodes 5 separated by a distance greater than the diameter of the drop to be displaced, and then to the application of a second voltage 6.

FIG. 2 therefore differs from FIG. 1 in that the positions of the electrode 4 and of the matrix of electrodes 5 are exchanged. Unlike the embodiment in FIG. 1, the electrode 4 is, in this case, below the matrix of electrodes 5.

The second voltage, applied between two or more electrodes of the matrix, makes it possible to displace the drop laterally. It has, for example, a frequency equal to or in the vicinity of the first voltage and its phase can be adjusted with respect to that of the first voltage.

In a configuration in which the displaced drops come into contact with the matrix of electrodes, in order to prevent electrolysis, the electrodes of the matrix are, for example, spaced out in such a way that a drop cannot overlap two electrodes with different potentials at the same time. It is also possible to prevent electrolysis by taking care not to place an electrode adjacent to that above which a drop jumps at a potential different than the potential of the electrode above which the drop jumps.

FIG. 3 illustrates the principle of vertical displacement of a volume of liquid under the action of an electrical voltage and dependent on the electrical voltage.

The amplitude of the first voltage U₁ is such that the electrostatic forces exerted on the drop to be displaced make it possible to detach it from the first electrode and the half-period τ of this voltage is less than the time of flight of the drop between the two electrode systems. As soon as this first voltage is applied, the drop continually detaches from an electrode and returns thereto: the electrostatic forces oppose wetting and the drop is therefore virtually never in contact with a solid surface.

FIGS. 4 to 6 show various advantageous electrode arrangements. The projected possible trajectories of a drop are also shown.

FIG. 4 illustrates a possible displacement of a small volume of liquid 1 over a line of electrodes 5 under the action of a voltage 6 applied between at least two electrodes of the matrix 5.

FIG. 5 illustrates a possible displacement of a small volume of liquid 1 over a central electrode 5a under the action of a voltage 6 applied between at least one electrode of the matrix 5b and the central electrode 5a.

FIG. 6 illustrates a possible displacement of a small volume of liquid 1 over a central electrode 5a under the action of a voltage 6 applied between at least one electrode of the matrix 5b and the central electrode 5a.

FIG. 7 illustrates an exemplary embodiment according to the present invention using dyes for producing a display device. The oil (used as dielectric) may be colored, so as to be dark in color, with a dye which does not migrate in an aqueous phase, such as the Solvent Blue 59 sold by the Aldrich Chemical Company, and the drops of water may be colored in other colors. In this embodiment, the drops 1 form the pixels 7 of a display, the glass screen 8 of which may be the glass cover described in the exemplary embodiment. The horizontal displacement enables the drops to be distributed and to be maintained at the various positions predefined for the pixels of the display device. The vertical displacement enables the change in color of the glass screen.

FIG. 8 illustrates the principle of coalescence of two drops 1 and 9 in which 3 refers to a first alternating voltage between an electrode 4 and one or more microelectrodes of the matrix 5, and 6 refers to another alternating voltage between an electrode 4 and a microelectrode of the matrix 5. The first voltage 3 allows the incessant vertical displacement of a drop 1. The second voltage 6 makes it possible to bring an electrode of the matrix 5 to a potential different than that applied by 3. This second voltage 6 in this case has the same frequency as 3, but has an opposite phase. The two drops 1 and 9 acquire, on contact with the electrodes of the matrix 5, opposite charges. The consequently attractive electrical force that is exerted between the drops leads to their coalescence.

The device of the present invention advantageously comprises a dielectric liquid between the first and the second substrate, the density of the dielectric preferably being close to the liquid to be displaced.

The supports of the device of the present invention may consist of various materials. The matrix of microelectrodes is preferably a printed circuit.

The electrodes preferably consist of a metal.

In the device of the present invention, it is preferable for one of the supports to consist essentially of glass or of a polymeric material. More particularly, the electrode produced on this support should be transparent.

The matrix of electrodes may extend along one or two dimensions.

In general, the second voltage has a frequency equal to or close to the first voltage. The phase and/or the amplitude of the second voltage can be adjusted with respect to that of the first voltage.

Preferably, the volume of liquid is, after displacement to the second substrate, maintained against the second electrode.

It is possible for the potential applied to two adjacent microelectrodes to be equal.

In the method according to the present invention, it is advantageously possible to cause two volumes of liquid to be displaced to coalesce by applying opposite charges when they are being brought closer together.

The present invention provides several specific advantages.

A volume of liquid (drop) displaced according to the method of the present invention is almost never in contact with a solid surface and the surface finishes are therefore much less critical than in the prior art devices. In particular, the lateral displacement of a drop takes place during a flight phase, during which only forces of inertia and viscous forces oppose the movement; the finishes of the solid surfaces have little influence.

The device and the method of the present invention have the ability to very easily cause two drops to coalesce during a protocol. In fact, it is sufficient for the two drops in question to have opposite charges when they are being brought closer together.

In addition, the device and the method of the present invention are compatible with French patent application FR 0450276 (corresponding to European patent application 05101090-8) which proposes a device for 3D displacement of conductive drops by electrostatic forces.

The following exemplary embodiments are in no way limiting. The embodiment described may be used in biological and/or chemical applications.

### EXEMPLARY EMBODIMENTS

The matrix of electrodes can be produced on a printed circuit, the gap between the electrodes being of the order of 200 μm. The printed circuit is coated with a very thin layer of Teflon (a few tens of nanometers). The cover is made of glass coated successively with a thin conductive layer made of ITO (indium tin oxide) (140 nm), with a dielectric layer of Si₃N₄ (300 nm), with a photosensitive dry film (100 μm) into which structures, for example wells, can be etched and, finally, a thin layer of a plasma-deposited hydrophobic material. The cover is separated from the matrix of electrodes by a distance of 2 to 4 mm. The dielectric used is, for example, a mineral oil, the density of which is close to 0.9 and the drops displaced are of water or milk having a volume of 1 μl.

1. A device for displacing a volume of liquid under the action of an electrical voltage, comprising:
a first substrate with a first electrode,
a second substrate with a second electrode, facing the first substrate, said second electrode comprising a matrix comprising a number of microelectrodes, characterized in that it comprises:
means (3) for applying a first alternating voltage between the first and second electrodes, the amplitude of the first voltage being such that the electrostatic forces exerted on the volume of liquid to be displaced (1) make it possible to detach it from an electrode and the half-period τ of the first voltage being less than the time of flight Tᵥ of the volume between the two electrodes, and
means (6) for applying a second voltage between at least two of said microelectrodes (5).

2. The device as claimed in claim 1, characterized in that it comprises a dielectric liquid (2) between the first and the second substrate.

3. The device as claimed in claim 2, characterized in that the density of the dielectric (2) is lower than or close to that of the liquid (1) to be displaced.

4. The device as claimed in claim 1, characterized in that the first substrate is a printed circuit.

5. The device as claimed in claim 1, characterized in that the first electrode consists essentially of a metal.

6. The device as claimed in claim 1, characterized in that the second support consists essentially of glass or of a polymeric material.

7. The device as claimed in claim 6, characterized in that the second electrode is transparent.

8. The device as claimed in claim 1, characterized in that the gap between the microelectrodes is less than the diameter of the volume of liquid to be displaced.

9. The device as claimed in claim 1, characterized in that the surface of the electrodes is textured.

10. The device as claimed in claim 9, characterized in that the texture has pads or a network of walls.

11. The device as claimed in claim 1, characterized in that the matrix of electrodes (5) extends along one or two dimensions.

12. A method for displacing a volume of liquid, in which said volume is initially in contact with a first substrate with a first electrode, facing a second substrate with a second electrode, one of said electrodes comprising a matrix comprising a number of microelectrodes, characterized in that it comprises the steps consisting in:
a) applying a first alternating voltage between the first and second electrodes (4, 5), the amplitude of the first voltage being such that the electrostatic forces exerted on the volume of liquid to be displaced (1) make it possible to detach it from an electrode and the half-period τ of the first voltage being less than the time of flight Tᵥ of the volume between the two electrodes,
b) applying a second voltage between at least two of said microelectrodes (5).

13. The method as claimed in claim 12, characterized in that the second voltage has a frequency equal to or in the vicinity of that of the first voltage.

14. The method as claimed in claim 13, characterized in that the phase and/or the amplitude of the second voltage can be adjusted with respect to that of the first voltage.

15. The method as claimed in claim 12, characterized in that the volume of liquid is, after displacement in the second substrate, maintained against the second electrode.

16. The method as claimed in claim 12, characterized in that the potential applied to two adjacent microelectrodes is equal.

17. The method as claimed in claim 12, for causing two volumes of liquid to be displaced to coalesce by applying opposite charges when they are being brought closer together.
